(19) United States
(12) Patent Application Publication
(10) Pub. No.: US 2002/0175030 A1
(43) Pub. Date: Nov. 28, 2002

(54) Brake shoe adjusting mechanism for disc brake device

(76) Inventor: Mu Kai Lee, Taichung (TW)

Correspondence Address: Mu Kai Lee, No 14, Lane 69, Sec. 4, Tien Gin Road, Taichung, 406, TW

(21) Appl. No.: 09/865,566

(22) Filed: May 25, 2001

(51) Int. Cl. F16D 55/00; F16D 65/38

(52) U.S. Cl. 188/73.31; 188/196 R; 188/71.7

(57) ABSTRACT

A disc brake device includes a brake disc having a peripheral portion received in a housing, two brake shoes disposed beside the brake disc, A bolt is threaded in the housing, and a control ferrule is rotatably secured to the housing and coupled to the bolt for rotating the bolt to adjust the brake shoe relative to the brake disc. A ring is threaded in the housing, and a knob is rotatably secured to the housing and coupled to the ring for rotating the ring to adjust the other brake shoe. The brake shoes may be easily adjusted with the control ferrule and the knob.

### BACKGROUND OF THE INVENTION

1. Field of the Invention

The present invention relates to a disc brake device, and more particularly to a disc brake device including a mechanism or an arrangement for allowing the users to adjust the brake shoe relative to the brake disc without experts.

2. Description of the Prior Art

Typical disc brake devices comprise two brake shoes disposed on the opposite sides of the peripheral portion of the brake disc for being forced to engage with and to brake the peripheral portion of the brake disc. When the brake shoes have been scraped or rubbed after use and have a decreased thickness, the brake shoes may not be easily adjusted relative to the brake disc by the users. Accordingly, after the brake shoes have been scraped or rubbed for a thickness that may not be suitably engaged with the brake disc, the brake shoes may only be moved or adjusted relative to the brake disc by the experts and by disengaging the parts or the elements of the brake disc device. The users may not easily disengage or disassemble the disc brake device.

The present invention has arisen to mitigate and/or obviate the afore-described disadvantages of the conventional disc brake devices.

### SUMMARY OF THE INVENTION

The primary objective of the present invention is to provide a disc brake device including a mechanism or an arrangement for allowing the users to adjust the brake shoe relative to the brake disc.

In accordance with one aspect of the invention, there is provided a disc brake device comprising a housing for securing to a cycle, the housing including a chamber formed therein, and including a first end and a second end, a brake disc including a peripheral portion received in the chamber of the housing, and including a first side and a second side, a first brake shoe disposed in the chamber of the housing and located at the first side of the brake disc, a second brake shoe disposed in the chamber of the housing and located at the second side of the brake disc, a control ferrule rotatably secured to the first end of the housing, and means for adjusting the first brake shoe relative to the brake disc with rotation of the control ferrule relative to the housing. The control ferrule may thus be easily rotated relative to the housing by the users in order to easily and quickly adjust the first brake shoe relative to the brake disc.

The adjusting means includes a seat slidably received in the chamber of the housing and located beside the first brake shoe.

A casing is further provided and secured in the housing and includes a bore formed therein, a movable member is received in the bore of the casing, and the control ferrule includes means for moving the movable member relative to the first brake shoe.

The control ferrule includes a channel formed therein, the movable member is a bolt threaded with the casing, the bolt includes an extension slidably received in the channel of the control ferrule.

The control ferrule includes a rod extended therefrom and rotatably received in the bore of the casing and having the channel formed therein.

A device is further provided for moving the second brake shoe relative to the brake disc and includes a ring threaded in the chamber of the housing and located beside the second brake shoe, the knob includes means for moving the ring relative to the second brake shoe. The knob may thus be easily rotated relative to the housing by the users in order to easily and quickly adjust the second brake shoe relative to the brake disc.

The knob includes at least one cavity formed therein, the ring includes at least one leg extended therefrom and engaged into the cavity of the knob for allowing the ring to be rotated relative to the housing with the knob.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a cross sectional view of a disc brake device in accordance with the present invention;

FIG. 2 is a partial exploded view of the disc brake device; and

FIGS. 3 and 4 are cross sectional views similar to FIG. 1, illustrating the operation of the disc brake device.

### DETAILED DESCRIPTION OF THE PREFERRED EMBODIMENT

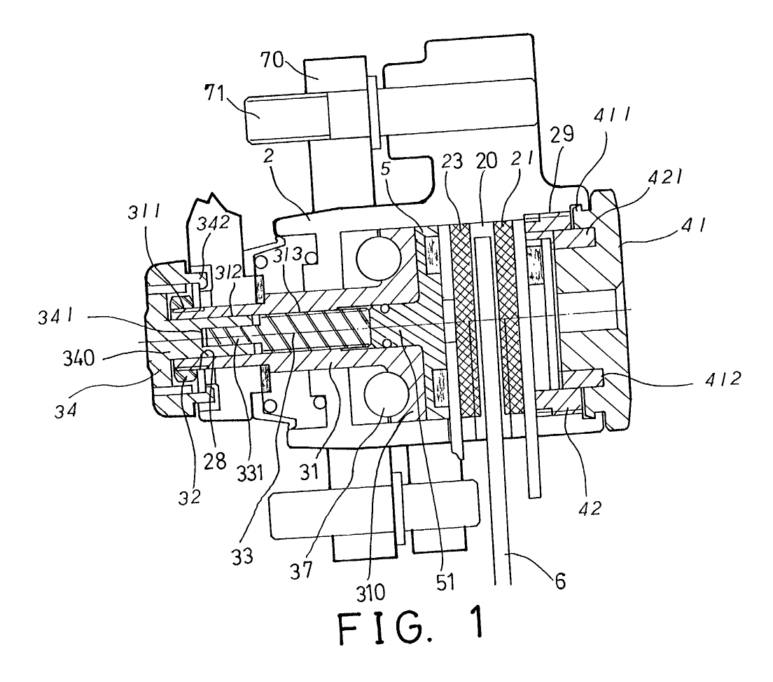

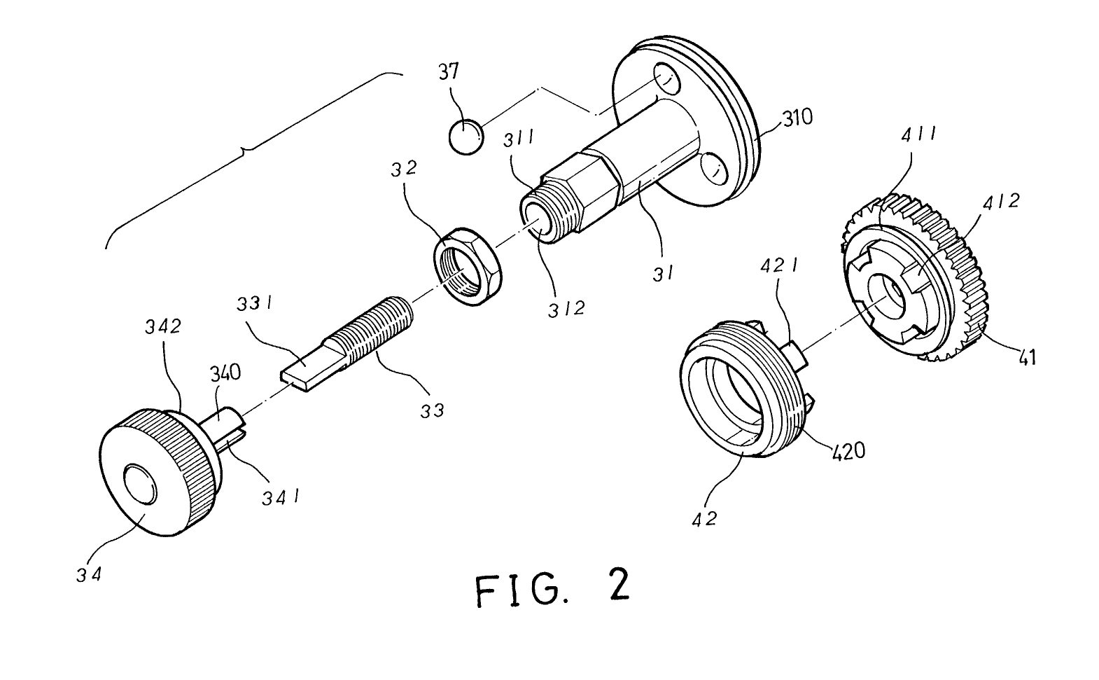

Referring to the drawings, and initially to FIGS. 1 and 2, a disc brake device in accordance with the present invention comprises a housing 2 secured to the vehicle body, particularly the bicycle or the motor cycle or the other cycles 70, with fasteners 71 or the like. The housing 2 includes a chamber 20 formed therein for receiving the peripheral portion of a brake disc 6. Two brake shoes 21, 23 are slidably received in the chamber 20 of the housing 2 and disposed on the opposite sides of the peripheral portion of the brake disc 6 for being forced to engage with and to brake the peripheral portion of the brake disc 6.

A casing 31 is received in a conduit 28 of the housing 2, and includes an enlarged head 310 formed or provided on one end thereof and retained in the chamber 20 of the housing 2 with balls 37 or the other bearings or the like, and includes the other end extended outward of the housing 2 and having an outer thread 311 formed thereon for threading with a lock nut 32 which may secure the casing 31 in the housing 2. The casing 31 includes a bore 312 formed therein, and an inner thread 313 formed in the bore 312 thereof. A seat 5 is slidably received in the chamber 20 of the housing 2 and secured to one (such as the left) of the brake shoes 23 with fasteners or the like, and includes a shaft 51 extended therefrom and slidably received in the bore 312 of the casing 31, such that the brake shoe 23 may be moved toward and away from the brake disc 6 by the seat 5.

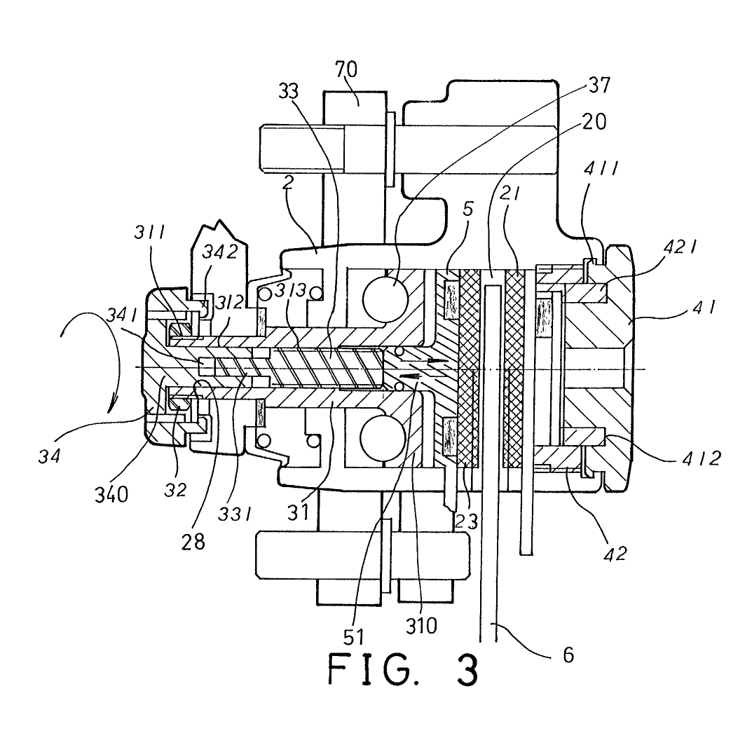

A rotary member, or a movable member, such as a bolt 33 is threaded with the inner thread 313 of the casing 31, and has an inner end engaged with the shaft 51 of the seat 5, and includes an extension 331 extended therefrom and having a non-circular cross section. A control ferrule 34 includes a catch, such as a peripheral catch 342 rotatably hooked and secured to one end of the housing 2, and includes a rod 340 extended therefrom and slidably engaged in the bore 312 of the casing 31 and having a channel 341 formed therein for slidably receiving the extension 331 of the bolt 33. The channel 341 of the rod 340 or of the control ferrule 34 includes a non-circular cross section corresponding to that of the extension 331 of the bolt 33, such that the bolt 33 may be rotated by the control ferrule 34 via the engagement of the extension 331 of the bolt 33 in the channel 341 of the control ferrule 34, and such that the seat 5 and thus the brake shoe 23 may be moved or forced to move toward and away from the brake disc 6 when the bolt 33 is rotated by the control ferrule 34 (FIG. 3). The brake shoe 23 may thus be easily and quickly moved or adjusted relative to the brake disc 6 by the users themselves, without experts. The extension 331 of the bolt 33 may also be keyed to the rod 340 of the control ferrule 34.

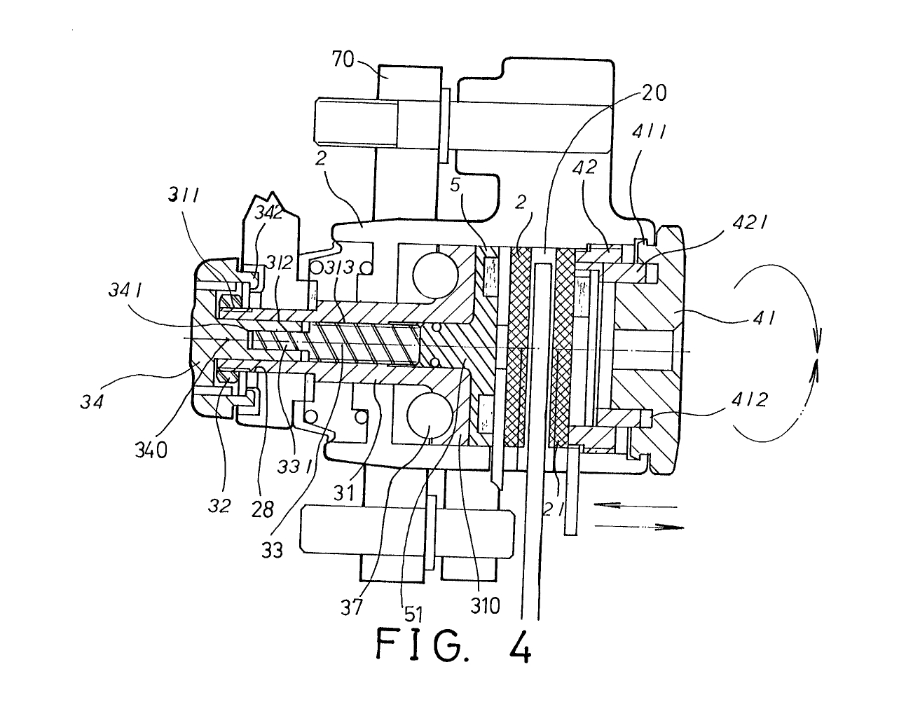

The housing 2 includes an inner thread 29 formed in the other end portion opposite to that of the control ferrule 34. A ring 42 includes an outer thread 420 formed thereon for threading with the inner thread 29 of the housing 2, and includes one or more legs 421 extended away from the brake shoes 21, 23. A knob 41 is rotatably secured to the other end of the housing 2 with a peripheral latch 411 or the like, and includes one or more cavities 412 formed therein for receiving the legs 421 of the ring 42 and for allowing the ring 42 to be rotated by the knob 41. As shown in FIG. 4, the ring 42 may thus be moved toward and away from the brake shoe 21 by the rotational movement of the knob 41 relative to the housing 2, in order to adjust the brake shoe 21 toward and away from the brake disc 6, particularly to adjust the brake shoe 21 toward the brake disc 6. The ring 42 may also be rotatably secured to the brake shoe 21 with a peripheral latch or the like, for allowing the brake shoe 21 to be moved away from the brake disc 6 by the knob 41 via the ring 42.

Accordingly, the disc brake device in accordance with the present invention includes a mechanism or an arrangement for allowing the users to adjust the brake shoe relative to the brake disc without experts.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A disc brake device comprising:
a housing for securing to a cycle, said housing including a chamber formed therein, and including a first end and a second end,
a brake disc including a peripheral portion received in said chamber of said housing, and including a first side and a second side,
a first brake shoe disposed in said chamber of said housing and located at said first side of said brake disc,
a second brake shoe disposed in said chamber of said housing and located at said second side of said brake disc,
a control ferrule rotatably secured to said first end of said housing, and
means for adjusting said first brake shoe relative to said brake disc with rotation of said control ferrule relative to said housing.

2. The disc brake device according to claim 1, wherein said adjusting means includes a seat slidably received in said chamber of said housing and located beside said first brake shoe.

3. The disc brake device according to claim 1 further comprising a casing secured in said housing and including a bore formed therein, a movable member received in said bore of said casing, and said control ferrule including means for moving said movable member relative to said first brake shoe.

4. The disc brake device according to claim 3, wherein said control ferrule includes a channel formed therein, said movable member is a bolt threaded with said casing, said bolt includes an extension slidably received in said channel of said control ferrule.

5. The disc brake device according to claim 4, wherein said control ferrule includes a rod extended therefrom and rotatably received in said bore of said casing and having said channel formed therein.

6. The disc brake device according to claim 1 further comprising means for moving said second brake shoe relative to said brake disc.

7. A disc brake device comprising:
a housing for securing to a cycle, said housing including a chamber formed therein, and including a first end and a second end,
a brake disc including a peripheral portion received in said chamber of said housing, and including a first side and a second side,
a first brake shoe disposed in said chamber of said housing and located at said first side of said brake disc,
a second brake shoe disposed in said chamber of said housing and located at said second side of said brake disc,
a knob rotatably secured to said second end of said housing, and
means for adjusting said second brake shoe relative to said brake disc with rotation of said knob relative to said housing.

8. The disc brake device according to claim 7, wherein said adjusting means includes a ring threaded in said chamber of said housing and located beside said second brake shoe, said knob includes means for moving said ring relative to said second brake shoe.

9. The disc brake device according to claim 8, wherein said knob includes at least one cavity formed therein, said ring includes at least one leg extended therefrom and engaged into said at least one cavity of said knob for allowing said ring to be rotated relative to said housing with said knob.

10. The disc brake device according to claim 7 further comprising means for moving said first brake shoe relative to said brake disc.
